(19) United States
(12) Patent Application Publication
(10) Pub. No.: US 2025/0293275 A1
(43) Pub. Date: Sep. 18, 2025

(54) COOLING DEVICE FOR FUEL CELL VEHICLE

(71) Applicant: TOYOTA JIDOSHA KABUSHIKI KAISHA, Toyota-shi (JP)

(72) Inventor: Keitaro YAMAMORI, Nagoya-shi (JP)

(73) Assignee: TOYOTA JIDOSHA KABUSHIKI KAISHA, Toyota-shi (JP)

(21) Appl. No.: 19/070,972

(22) Filed: Mar. 5, 2025

(30) Foreign Application Priority Data
Mar. 12, 2024 (JP) 2024-038509

(51) Int. Cl. H01M 8/04007; B60K 11/04; B60L 50/70

(52) U.S. Cl. CPC H01M 8/04059; B60K 11/04; H01M 8/04067; B60L 50/70; H01M 2250/20

(57) ABSTRACT

A cooling device for a fuel cell vehicle that includes a fuel cell stack. The cooling device includes a condenser, a radiator and a fan that are stored in a front storage room of the vehicle. The condenser, the radiator and the fan are arranged in this order of description as seen in a longitudinal direction of the vehicle, which is a direction away from a front side of the vehicle toward a rear side of the vehicle. The condenser is smaller than the radiator in area as seen in the longitudinal direction. The condenser and the radiator are located relative to each other, such that a center position of the condenser is within the radiator as seen in the longitudinal direction, and such that the center position of the condenser is offset from a center position of the radiator toward an upper side of the vehicle.

This application claims priority from Japanese Patent Application No. 2024-038509 filed on Mar. 12, 2024, the disclosure of which is herein incorporated by reference in its entirety.

### FIELD OF THE INVENTION

The present invention relates to a cooling device for a fuel cell vehicle that includes a fuel cell stack.

### BACKGROUND OF THE INVENTION

There is known a cooling device that includes a condenser, a radiator and a fan that are stored in a front storage room in which an engine is disposed, such that the condenser, the radiator and the fan are arranged in this order of description as seen in a longitudinal direction of a fuel cell vehicle which is a direction away from a front side of the fuel cell vehicle toward a rear side of the fuel cell vehicle. For example, Patent Document 1 discloses such a cooling device. In the cooling device disclosed in in Patent Document 1, a center position of the condenser, a center position of the radiator and a center position of the fan are in the same position in a vertical direction of the fuel cell vehicle.

### PRIOR ART DOCUMENT

### Patent Document

[Patent Document 1]

Japanese Patent Application Laid-Open No. 2017-223141

### SUMMARY OF THE INVENTION

By the way, unlike an internal combustion engine vehicle with an engine (=internal combustion engine) that burns a fossil fuel such as gasoline as a power source, a fuel cell vehicle is known as a vehicle which is equipped with a fuel cell stack that generates an electric power using hydrogen as fuel and which uses an electric motor driven by the electric power generated by the fuel cell stack as a power source. The “fuel cell stack” is a structure including cells of a fuel cell that generates an electric power using hydrogen as a fuel, wherein the cells are stacked and combined. The fuel cell vehicle has a higher energy conversion efficiency for converting a potential energy of the fuel into a power, but has a smaller exhaust loss, as compared with the internal combustion engine vehicle. Therefore, it is necessary to radiate most of a heat generation amount, which is a loss, to a refrigerant of the cooling device. In addition, in order to ensure a heat resistance of an ion exchange membrane constituting the fuel cell, it is necessary to lower an upper limit temperature of a refrigerant for cooling the fuel cell stack, as compared with an upper limit temperature of a refrigerant for cooling the engine in the internal combustion engine vehicle. Under these circumstances, the fuel cell vehicle is required to have an improved cooling performance as compared with the internal combustion engine vehicle.

The present invention has been made in view of the above circumstances, and an object of the present invention is to provide a cooling device for a fuel cell vehicle, wherein the cooling device has an improved cooling performance.

A first aspect of the present invention is a cooling device for a fuel cell vehicle that includes a fuel cell stack. The cooling device includes a condenser, a radiator and a fan that are stored in a front storage room of the fuel cell vehicle. The condenser, the radiator and the fan are arranged in this order of description as seen in a longitudinal direction of the fuel cell vehicle which is a direction away from a front side of the fuel cell vehicle toward a rear side of the fuel cell vehicle. The condenser is smaller than the radiator in area as seen in the longitudinal direction. The condenser and the radiator are located relative to each other, such that a center position of the condenser is within the radiator as seen in the longitudinal direction, and such that the center position of the condenser is offset from a center position of the radiator in a vertical direction of the fuel cell vehicle, toward an upper side of the fuel cell vehicle.

A second aspect of the present invention is that, in the cooling device according to the first aspect of the invention, the condenser and the radiator are located relative to each other, such that the center position of the condenser is offset from the center position of the radiator in a lateral direction of the fuel cell vehicle, toward a side on which a rate of flow of an outside air taken into the front storage room is lower than on another side.

A third aspect of the present invention is that, in the cooling device according to the first or second aspect of the present invention, the condenser, the radiator and the fan are located relative to one another, such that a center position of the fan is within the radiator as seen in the longitudinal direction, and such that the center position of the condenser and the center position of the fan are offset from the center position of the radiator in respective directions that are opposite to each other.

A fourth aspect of the present invention is that, in the cooling device according to the third aspect of the present invention, the fan and the fuel cell stack are located relative to each other, such that the fan overlaps with the fuel cell stack as seen in the vertical direction.

A fifth aspect of the present invention is that, in the cooling device according to any one of the first to fourth aspects of the present invention, the condenser and the radiator are located relative to each other, such that an entirety of the condenser is within the radiator as seen in the longitudinal direction.

In the cooling device according to the first aspect of the present invention, (a) the condenser, the radiator and the fan are arranged in this order of description as seen in the longitudinal direction of the fuel cell vehicle which is a direction away from the front side of the fuel cell vehicle toward the rear side of the fuel cell vehicle, (b) the condenser is smaller than the radiator in area as seen in the longitudinal direction, and (c) the condenser and the radiator are located relative to each other, such that the center position of the condenser is within the radiator as seen in the longitudinal direction, and such that the center position of the condenser is offset from the center position of the radiator in the vertical direction of the fuel cell vehicle, toward the upper side of the fuel cell vehicle. Since the condenser is located to be offset toward the upper side of the fuel cell vehicle, a ventilation resistance to a cooling air reaching the radiator located on a rear side of the condenser can be reduced, and a temperature rise of the cooling air for cooling the radiator can be suppressed. Thus, the cooling performance can be improved in the fuel cell vehicle.

In the cooling device according to the second aspect of the present invention, the condenser and the radiator are located relative to each other, such that the center position of the condenser is offset from the center position of the radiator in the lateral direction of the fuel cell vehicle, toward the side on which the rate of flow of the outside air taken into the front storage room is lower than on another side. Since the condenser is located to be offset in the lateral direction, toward the side on which the rate of flow of the outside air taken into the front storage room is lower than on another side, the ventilation resistance to the cooling air reaching the radiator located on the rear side of the condenser can be reduced. Thus, the cooling performance can be further improved in the fuel cell vehicle.

In the cooling device according to the third aspect of the present invention, the condenser, the radiator and the fan are located relative to one another, such that the center position of the fan is within the radiator as seen in the longitudinal direction, and such that the center position of the condenser and the center position of the fan are offset from the center position of the radiator in respective directions that are opposite to each other. Thus, the fan is located to be offset in the direction opposite to the condenser as seen in the longitudinal direction. This makes it easier for the cooling air to be drawn into a portion of the radiator located on the rear side of the condenser, wherein the portion does not overlap with the condenser located on the front side of the radiator, as seen in the longitudinal direction, so that the cooling performance can be further improved in the fuel cell vehicle.

In the cooling device according to the fourth aspect of the present invention, the fan and the fuel cell stack are located relative to each other, such that the fan overlaps with the fuel cell stack as seen in the vertical direction. Since the fan is located to be offset in the direction opposite to the condenser, the fan and the fuel cell stack located on the rear side of the fan can be easily located in respective positions overlapping with each other as seen in the vertical direction. Owing to such an arrangement, the fuel cell stack and the cooling device, which is constituted by the condenser, the radiator and the fan, can be reduced in size as a whole in the longitudinal direction. This improves a degree of freedom in installing various components in the front storage room.

In the cooling device according to the fifth aspect of the present invention, the condenser and the radiator are located relative to each other, such that the entirety of the condenser is within the radiator as seen in the longitudinal direction, so that the condenser and the radiator constituting the cooling device are prevented from being increased in size as a whole as seen in the longitudinal direction. Thus, it is possible to suppresses a reduction in the degree of freedom in installing various components in the front storage room.

### BRIEF DESCRIPTION OF THE DRAWINGS

FIG. 1 is a view showing a cooling device according to the present invention, wherein a condenser, a radiator and a fan are arranged in this order of description in a longitudinal direction of a fuel cell vehicle which is a direction away from a front side of the fuel cell vehicle toward a rear side of the fuel cell vehicle.

FIG. 2 is a view showing the condenser, the radiator and the fan of the cooling device shown in FIG. 1, as seen in the above-described longitudinal direction.

### DETAILED DESCRIPTION OF PREFERRED EMBODIMENT

Hereinafter, an embodiment of the present invention will be described in detail with reference to drawings. In the drawings of the embodiment, the drawings are simplified or modified as appropriate, and dimensional ratios, shapes and the like of respective parts are not necessarily accurately drawn.

### Embodiment

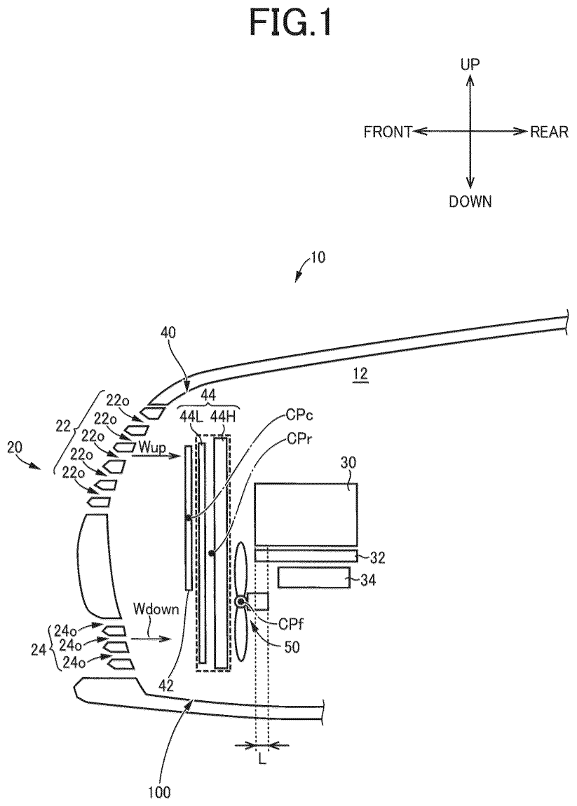

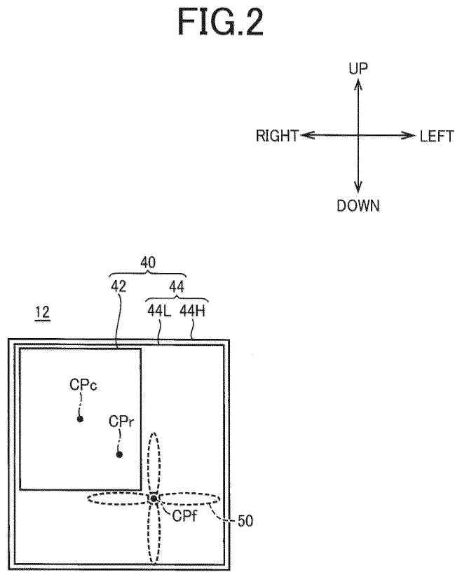

FIG. 1 shows a cooling device 100 according to the embodiment of the present invention, wherein the cooling device 100 includes a condenser 42, a radiator 44 and a fan 50 that are arranged in this order of description in a longitudinal direction of a fuel cell vehicle 10 (hereinafter, simply referred to as “vehicle 10”) which is a direction away from a front side of the vehicle 10 toward a rear side of the vehicle 10. FIG. 1 is a view as seen in a lateral direction of the vehicle 10. In FIG. 1, a rightward direction corresponds to a forward direction of the vehicle 10, a leftward direction corresponds to a reverse direction of the vehicle 10, an upward direction corresponds to an upper direction of the vehicle 10, and a downward direction corresponds to a lower direction of the vehicle 10. FIG. 2 is a view showing the condenser 42, the radiator 44 and the fan 50 of the cooling device 100 shown in FIG. 1, as seen in the above-described longitudinal direction, i.e., in the direction away from the front side of the vehicle 10 toward the rear side of the vehicle 10. In FIG. 2, a front grille 20 shown in FIG. 1 is not shown. In FIG. 2, a leftward direction corresponds to a right direction of the vehicle 10, a rightward direction corresponds to a left direction of the vehicle 10, an upward direction corresponds to an upper direction of the vehicle 10, and a downward direction corresponds to a lower direction of the vehicle 10. In the following descriptions, “longitudinal direction view” means a view of the vehicle 10 as seen in the above-described longitudinal direction that is the direction away from the front side of the vehicle 10 toward the rear side of the vehicle 10, and “vertical direction view” means a view of the vehicle 10 as seen in a direction away from an upper side of the vehicle 10 toward a lower side of the vehicle 10.

The vehicle 10 includes a fuel cell stack 30 and the cooling device 100 that cools heat generated in the fuel cell stack 30. The fuel cell stack 30 and the cooling device 100 are stored in a front storage room 12 of the vehicle 10. The front storage room 12 is a space provided on a front side of a driver's seat in the vehicle 10.

The cooling device 100 includes the condenser 42, the radiator 44 and the fan 50. The condenser 42 is, for example, a heat exchanger that cools a refrigerant of an air conditioner that performs air conditioning in a vehicle interior, with an outside air, and has a known construction. The radiators 44 include, for example, a low-temperature radiator 44L and a high-temperature radiator 44H. The high-temperature radiator 44H is a heat exchanger that cools a refrigerant cooling the fuel cell stack 30, with the outside air, and has a known construction. The low-temperature radiator 44L is a heat exchanger that cools a refrigerant cooling drive devices other than the fuel cell stack 30, with the outside air, and has a known construction. For example, the condenser 42 and the radiator 44 are fixed to each other to constitute an assembly 40 before they are installed in the vehicle 10. The assembly 40 is an assembly of components in which a plurality of components that are the condenser 42 and the radiator 44, are integrally fixed to each other. The condenser 42 and the radiator 44 that constitute the assembly 40 are installed in the vehicle 10.

Here, a temperature of the refrigerant cooled by the condenser 42 is referred to as “refrigerant temperature THc [° C.]”, a temperature of the refrigerant cooled by the low-temperature radiator 44L is referred to as “refrigerant temperature THrl [° C.]”, and a temperature of the refrigerant cooled by the high-temperature radiator 44H is referred to as “refrigerant temperature THrh [° C.]”. Among the “refrigerant temperature THc”, the “refrigerant temperature THrl”, and the “refrigerant temperature THrh”, the “refrigerant temperature THc” is the lowest, the “refrigerant temperature THrl” is the second lowest, and the “refrigerant temperature THrh” is the highest.

The fan 50 is a device that draws an outside air from the front side of the vehicle 10 and causes the outside air to flow rearward in the front storage room 12 by a rotating impeller, and is, for example, a known electric or mechanical fan.

The outside air is taken into the front storage room 12 through an upper opening portion 22 having a plurality of openings 220 and through a lower opening portion 24 having a plurality of openings 240, which are provided in the front grille 20. A flow of the outside air taken through the upper opening portion 22 is referred to as a cooling wind Wup, and a flow of the outside air taken through from the lower opening portion 24 is referred to as a cooling wind Wdown.

Here, a wind pressure [Pa] applied to a vehicle body (i.e., a body of the vehicle 10) when the vehicle 10 is running is referred to as a “ram pressure”. In the front grille 20 of the vehicle 10, the outside air flowing from the front side during running of the vehicle 10 is relatively unlikely to escape to outside of the lower opening portion 24 on a lower portion of the front grille 20, while the outside air flowing from the front side during running of the vehicle 10 is relatively likely to escape to outside of the upper opening portion 22 on an upper portion of the front grille 20. In the front grille 20 of the car 10, the upper opening portion 22 having the plurality of openings 220 is formed to be inclined rearward as it extends upward in order to reduce an air resistance during running of the car 10, while the lower opening portion 24 having the plurality of openings 240 is formed to be inclined rearward as it extends downward, such that the rearward inclination of the lower opening portion 24 is smaller than the rearward inclination of the upper opening portion 22. It is considered that the ram pressure is larger in the lower opening portion 24 than in the upper opening portion 22.

In the present embodiment, in the longitudinal direction view, an opening area of the upper opening portion 22 is larger than an opening area of the lower opening portion 24. However, the present inventor has newly obtained a knowledge that a flow rate [m³/s] of the cooling air Wdown could be higher than a flow rate [m³/s] of the cooling air Wup. This is considered to be because an influence of the ram pressure may be larger than a magnitude relation between the opening areas of the upper opening portion 22 and the lower opening portion 24.

In the cooling device 100, the condenser 42, the radiator 44 and the fan 50 are arranged in this order of description as seen in the longitudinal direction of the vehicle 10, i.e., in the direction away from the front side of the vehicle 10 toward the rear side of the vehicle 10. The fuel cell stack 30 is disposed on a read side of the cooling device 100. Hydrogen and air as fuel are supplied to the fuel cell stack 30 from auxiliary machinery 34 including a pump and an injector. The fuel cell stack 30 and the auxiliary machinery 34 are supported by, for example, a support structure 32.

For example, the condenser 42, the low-temperature radiator 44L and the high-temperature radiators 44H each have a substantially rectangular parallelepiped outer shape, and are provided with a plurality of holes for ventilation that penetrate therethrough in the longitudinal direction of the vehicle 10.

As shown in FIG. 2, the condenser 42 is smaller in area than the radiator 44 in the longitudinal direction view. In the longitudinal direction view, a center of the condenser 42 is located in a center position CPc, a center of the radiator 44 is located in a center position CPr, and a center of the fan 50 is located in a center position CPf. The positions of the centers of the condenser 42, radiator 44 and fan 50 are geometric centers of shapes of the condenser 42, radiator 44 and fan 50 in the longitudinal direction view. The center position CPc corresponds to “center position of the condenser” in the present invention, the center position CPr corresponds to “center position of the radiator” in the present invention, and the center position CPf corresponds to “center position of the fan” in the present invention.

The condenser 42 and the radiator 44 are located relative to each other such that the center position CPc of the condenser 42 is within the radiator 44 in the longitudinal direction view, namely, the radiator 44 and the condenser 42 at least partially overlap with each other in the longitudinal direction view. The condenser 42 and the fan 50 are located relative to each other such that the center position CPc of the condenser 42 is offset from the center position CPr of the radiator 44 in a vertical direction of the vehicle 10, toward an upper side of the vehicle 10. The term “being offset” means “being deviated”. With such an arrangement, in a total rate of flow of air sequentially passing through the condenser 42, the low-temperature radiator 44L and the high-temperature radiator 44H, a ratio of the flow rate of the cooling air Wup is higher than a ratio of the flow rate of the cooling air Wdown. Meanwhile, in a total rate of flow of air passing through the low-temperature radiator 44L and the high-temperature radiator 44H without passing through the condenser 42, a ratio of the flow rate of the cooling air Wdown is higher than a ratio of the flow rate of the cooling air Wup.

The cooling air Wup rather than the cooling air Wdown is mainly caused to pass through a portion that is provided with the condenser 42 in which the refrigerant is cooled to the refrigerant temperature THc that is the lowest among the refrigerant temperatures THc, THrl and THrh. The cooling air Wdown rather than the cooling air Wup is mainly caused to pass through a portion that is provided with the radiator 44 in which the refrigerant is cooled to the refrigerant temperatures THrl and THrh that are higher than the refrigerant temperature THc.

The temperature of the refrigerant to be cooled is higher in the radiator 44 than in the condenser 42. In this way, the radiator 44, in which the temperature of the refrigerant to be cooled is high, is mainly cooled by the cooling air Wdown that does not pass through the condenser 42 in a lower portion of the vehicle 10, namely, on side of the cooling air Wdown whose flow rate is higher than the flow rate of the cooling air Wup. The cooling air Wdown cools the radiator 44 in a state where a ventilation resistance to the radiator 44 is lower than that of the cooling air Wup. The “ventilation resistance” is a resistance to flow of the cooling air Wup or the cooling air Wdown until the cooling air Wup or the cooling air Wdown reaches the condenser 42 and the radiator 44 that are included in the cooling device 100.

By the way, in general, in a conventional internal combustion engine vehicle, the condenser 42 has substantially the same area as the radiator 44 in the longitudinal direction view, and the condenser 42 and the radiator 44 are located relative to each other such that the center position CPc of the condenser 42 and the center position CPr of the radiator 44 are not deviated from each other in the longitudinal direction view. The reason for this conventional arrangement is that requirement for cooling performance was low. Further, even if the area of the condenser 42 is made smaller than that of the radiator 44 in the longitudinal direction view, the center position CPc of the condenser 42 tends to be disposed so as to be offset downward with respect to the center position CPr of the radiator 44 in the vertical direction of the vehicle 10. The reason for this arrangement is that a center of gravity of the entire vehicle can be lowered and the assembly 40 can be easily manufactured. The easiness of manufacturing the assembly 40 means that the condenser 42 and the radiator 44 are easily manufactured by aligning their lower end portions when the condenser 42 and the radiator 44 are integrally assembled as the assembly 40.

The description of the present embodiment will be resumed. For example, when the flow rate of the cooling air Wup taken into the front storage room 12 through the upper opening portion 22 of the vehicle 10 is higher on the left side than on the right side, the condenser 42 and the radiator 44 are located relative to each other, such that the center position CPc of the condenser 42 is offset from the center position CPr of the radiator 44 in the longitudinal direction view, namely, the center position CPc of the condenser 42 is offset from the center position CPr of the radiator 44 in a lateral direction of the vehicle 10, toward a side on which the rate of flow of the outside air taken into the front storage room 12 is smaller than on another side.

The radiator 44 is disposed so as to include the center position CPf of the fan 50 in the longitudinal direction view. That is, the radiator 44 and the fan 50 are disposed so as to at least partially overlap each other in the longitudinal direction view. The center position CPf of the fan 50 is offset in a direction opposite to the center position CPc of the condenser 42 with respect to the center position CPr of the radiator 44. That is, the center position CPc of the condenser 42 is offset upward and rightward with respect to the center position CPr of the radiator 44. On the other hand, the center position CPf of the fan 50 is offset downward and leftward with respect to the center position CPr of the radiator 44.

The fan 50 is disposed in a position overlapping with the fuel cell stack 30 in the vertical direction view. In the present embodiment, as shown in FIG. 1, the fan 50 is disposed in a position overlapping with the fuel cell stack 30 by a length L [m] in the longitudinal direction. That is, in the longitudinal direction, the fuel cell stack 30 and the cooling device 100, which is constituted by the condenser 42, the radiator 44 and the fan 50, are reduced in size by the length L as a whole.

In the longitudinal direction view, the condenser 42 is disposed within a range of the

radiator 44. That is, in the longitudinal direction view, an outer contour of the condenser 42 does not protrude out an outer contour of the radiator 44.

In the cooling device 100 according to the present embodiment, (a) the condenser 42, the radiator 44 and the fan 50 are arranged in this order of description as seen in the longitudinal direction of the vehicle 10 which is the direction away from the front side of the vehicle 10 toward the rear side of the vehicle 10, (b) the condenser 42 is smaller than the radiator 44 in area as seen in the longitudinal direction, and (c) the condenser 42 and the radiator 44 are located relative to each other, such that the center position CPc of the condenser 42 is within the radiator 44 as seen in the longitudinal direction, and such that the center position CPc of the condenser 42 is offset from the center position CPr of the radiator 44 in the vertical direction of the vehicle 10, toward the upper side of the vehicle 10. Since the condenser 42 is located to be offset toward the upper side of the vehicle 10, the ventilation resistance to the cooling air reaching the radiator 44 located on the rear side of the condenser 42 can be reduced, and the temperature rise of the cooling air for cooling the radiator 44 can be suppressed. Thus, the cooling performance can be improved in the vehicle 10.

In the cooling device 100 according to the present embodiment, the condenser 42 and the radiator 44 are located relative to each other, such that the center position CPc of the condenser 42 is offset from the center position CPr of the radiator 44 in the lateral direction of the vehicle 10, toward the side on which the rate of flow of the outside air taken into the front storage room 12 is lower than on another side. Since the condenser 42 is located to be offset in the lateral direction, toward the side on which the rate of flow of the outside air taken into the front storage room 12 is lower than on another side, the ventilation resistance to the cooling air Wup reaching the radiator 44 located on the rear side of the condenser 42 can be reduced. Thus, the cooling performance can be further improved in the vehicle 10.

In the cooling device 100 according to the present embodiment, the condenser 42, the radiator 44 and the fan 50 are located relative to one another, such that the center position CPf of the fan 50 is within the radiator 44 as seen in the longitudinal direction, and such that the center position CPc of the condenser 42 and the center position CPf of the fan 50 are offset from the center position CPr of the radiator 44 in respective directions that are opposite to each other. Thus, the fan 50 is located to be offset in the direction opposite to the condenser 42 as seen in the longitudinal direction. This makes it easier for the cooling airs Wup, Wdown to be drawn into a portion of the radiator 44 located on the rear side of the condenser 42, wherein the portion does not overlap with the condenser 42 located on the front side of the radiator 44, as seen in the longitudinal direction, so that the cooling performance can be further improved in the vehicle 10.

In the cooling device 100 according to the present embodiment, the fan 50 and the fuel cell stack 30 are located relative to each other, such that the fan 50 overlaps with the fuel cell stack 30 as seen in the vertical direction. Since the fan 50 is located to be offset in the direction opposite to the condenser 42, the fan 50 and the fuel cell stack 30 located on the rear side of the fan 50 can be easily located in respective positions overlapping with each other as seen in the vertical direction. Owing to such an arrangement, the fuel cell stack 30 and the condenser 42, the fuel cell stack 30 and the cooling device 100, which is constituted by the condenser 42, the radiator 44 and the fan 50, can be reduced in size as a whole in the longitudinal direction. This improves a degree of freedom in installing various components in the front storage room 12.

In the cooling device 100 according to the present embodiment, the condenser 42 and the radiator 44 are located relative to each other, such that the entirety of the condenser 42 is within the radiator 44 as seen in the longitudinal direction, so that the condenser 42 and the radiator 44 constituting the cooling device 100 are prevented from being increased in size as a whole as seen in the longitudinal direction. Thus, it is possible to suppresses a reduction in the degree of freedom in installing various components in the front storage room 12.

The present invention can be implemented in various forms with various modifications and improvements based on the knowledge of those skilled in the art without departing from the scope of the present invention.

In the above-described embodiment, the center position CPc of the condenser 42 is located to be offset from the center position CPr of the radiator 44 in the lateral direction of the vehicle 10, toward the side on which the rate of flow of the outside air taken into the front storage room 12 is lower than on another side. However, the present invention is not limited to this arrangement. For example, the center position CPc of the condenser 42 may be substantially aligned with the center position CPr of the radiator 44 as seen in the vertical direction. Even in such an arrangement, as long as the center position CPc of the condenser 42 is offset from the center position CPr of the radiator 44 in the vertical direction, toward the upper side of the vehicle 10, the cooling performance can be improved in the vehicle 10, as compared to a case where the center position CPc of the condenser 42 is not offset from the center position CPr of the radiator 44 in the vertical direction, toward the upper side of the vehicle 10.

In the above-described embodiment, the center position CPf of the fan 50 is within the radiator 44 as seen in the longitudinal direction, and the center position CPc of the condenser 42 and the center position CPf of the fan 50 are offset from the center position CPr of the radiator 44 in respective directions that are opposite to each other. However, the present invention is not limited to this arrangement. For example, the center position CPf of the fan 50 may not be within the radiator 44 as seen in the longitudinal direction, and the center position CPc of the condenser 42 and the center position CPf of the fan 50 may be offset from the center position CPr of the radiator 44 in respective directions that are not opposite to each other. Even in such a case, as long as the center position CPc of the condenser 42 is offset from the center position CPr of the radiator 44 in the vertical direction, toward the upper side of the vehicle 10, the cooling performance can be improved in the vehicle 10, as compared to a case where the center position CPc of the condenser 42 is not offset from the center position CPr of the radiator 44 in the vertical direction, toward the upper side of the vehicle 10.

In the above-described embodiment, the fan 50 overlaps with the fuel cell stack 30 as seen in the vertical direction. However, the present invention is not limited to this arrangement. For example, the fan 50 may be located in a position not overlapping with the fuel cell stack 30 as viewed in the vertical direction. Even in such a case, as long as the center position CPc of the condenser 42 is offset from the center position CPr of the radiator 44 in the vertical direction, toward the upper side of the vehicle 10, the cooling performance can be improved in the vehicle 10, as compared to a case where the center position CPc of the condenser 42 is not offset from the center position CPr of the radiator 44 in the vertical direction, toward the upper side of the vehicle 10.

In the above-described embodiment, the entirety of the condenser 42 is within the radiator 44 as seen in the longitudinal direction. However, the present invention is not limited to this arrangement. For example, the condenser 42 may be disposed so as to protrude out the outer contour of the radiator 44 as seen in the longitudinal direction view. Even in such a case, as long as the center position CPc of the condenser 42 is offset from the center position CPr of the radiator 44 in the vertical direction, toward the upper side of the vehicle 10, the cooling performance can be improved in the vehicle 10, as compared to a case where the center position CPc of the condenser 42 is not offset from the center position CPr of the radiator 44 in the vertical direction, toward the upper side of the vehicle 10.

In the above-described embodiment, the opening area of the upper opening portion 22 is larger than the opening area of the lower opening portion 24. However, the present invention is not limited to this arrangement. For example, the present invention is applicable to an arrangement in which the opening area of the upper opening portion 22 is equal to or smaller than the opening area of the lower opening portion 24. Even in such a case, the ram pressure is larger in the lower opening portion 24 than in the upper opening portion 22. Therefore, as long as the center position CPc of the condenser 42 is offset from the center position CPr of the radiator 44 in the vertical direction, toward the upper side of the vehicle 10, the radiator 44 can be efficiently cooled by the cooling air Wdown having a high flow density, so that the cooling performance can be improved in the vehicle 10.

### Nomenclature of Elements

10: fuel cell vehicle
12: front storage room
30: fuel cell stack
42: condenser
44: radiator
50: fan
100: cooling device
CPc: center position (center position of condenser)
CPr: center position (center position of radiator)
CPf: center position (center position of fan)

What is claimed is:

1. A cooling device for a fuel cell vehicle that includes a fuel cell stack,
the cooling device comprising a condenser, a radiator and a fan that are stored in a front storage room of the fuel cell vehicle,
wherein the condenser, the radiator and the fan are arranged in this order of description as seen in a longitudinal direction of the fuel cell vehicle, which is a direction away from a front side of the fuel cell vehicle toward a rear side of the fuel cell vehicle,
wherein the condenser is smaller than the radiator in area as seen in the longitudinal direction, and
wherein the condenser and the radiator are located relative to each other, such that a center position of the condenser is within the radiator as seen in the longitudinal direction, and such that the center position of the condenser is offset from a center position of the radiator in a vertical direction of the fuel cell vehicle, toward an upper side of the fuel cell vehicle.

2. The cooling device according to claim 1,
wherein the condenser and the radiator are located relative to each other, such that the center position of the condenser is offset from the center position of the radiator in a lateral direction of the fuel cell vehicle, toward a side on which a rate of flow of an outside air taken into the front storage room is lower than on another side.

3. The cooling device according to claim 1,
wherein the condenser, the radiator and the fan are located relative to one another, such that a center position of the fan is within the radiator as seen in the longitudinal direction, and such that the center position of the condenser and the center position of the fan are offset from the center position of the radiator in respective directions that are opposite to each other.

4. The cooling device according to claim 3,
wherein the fan and the fuel cell stack are located relative to each other, such that the fan overlaps with the fuel cell stack as seen in the vertical direction.

5. The cooling device according to claim 1,
wherein the condenser and the radiator are located relative to each other, such that an entirety of the condenser is within the radiator as seen in the longitudinal direction.
